(19) United States
(12) Patent Application Publication
(10) Pub. No.: US 2002/0198721 A1
(43) Pub. Date: Dec. 26, 2002

(54) Device having speech-control means and having test-means for testing a function of the speech-control means

(75) Inventor: Thomas Weiser, Vienna (AT)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS.

(21) Appl. No.: 10/177,685

(22) Filed: Jun. 21, 2002

(30) Foreign Application Priority Data
Jun. 22, 2001 (EP) 01 890 195.9

(51) Int. Cl. G10L 11/00

(52) U.S. Cl. 704/275

(57) ABSTRACT

In the case of a device (1) having at least one controllable device portion (2, 3, 4, 5) and having voice control means (9) which are designed for voice-actuated control of the at least one device portion (2, 3, 4, 5), test means (15) are provided which are designed to test functioning of the voice control means (9).

The invention relates to a device having at least one controllable device part, which device comprises voice control means which are designed for voice-actuated control of the at least one device part.

The invention further relates to a method of controlling at least one controllable device part of a device, which method comprises the following steps, namely voice-actuated control of the at least one device part by means of voice control means, which voice control means are designed to control the at least one device part by means of a receivable acoustic signal.

Such a device of the type described above in the first paragraph and such a method of the type described above in the second paragraph are known from U.S. Pat. No. 4,827,520 A.

The known device, which forms a vehicle, comprises voice control means which are designed for voice-actuated control of vehicle accessories, such as for example a radio or a cell phone. To this end, the voice control means are designed to receive an acoustic signal and, if the received acoustic signal is generated by a user and comprises a voice control command recognizable by the voice control means, to generate and output control data corresponding to the recognized voice control command to control the vehicle accessory. In the case of the known voice control means, it is further provided that, where difficulties arise in the recognition of voice control commands, the user may adapt the voice control means to his/her personal speech characteristics by retraining the voice control means so that they recognize voice control commands. In the case of such difficulties, provision is additionally made for the voice control means to prompt the user to confirm a recognized voice command before the control data are fed to the vehicle accessory.

In the case of the known device, the user of the device is confronted with the problem that, in unfavorable cases, even retraining of the voice control means may possibly not lead to the desired success in recognizing voice control commands, for example because the vocal characteristics have changed due to environmental influences or an unstable state of health. Furthermore, retraining of the voice control means for better recognition of the voice control commands is associated with a considerable time commitment and in practice is therefore often not practical for the user, especially when repeated retraining has already failed to produce the desired success in the recognition of voice control commands. Even confirmation of a recognized voice control command cannot overcome the, from the user's subjective standpoint, obvious inadequate functioning or malfunctioning of the voice control means of the vehicle.

A user confronted with this difficulty with regard to voice-actuated control of the vehicle accessories during operation of the vehicle will complain about the inadequate functioning or malfunctioning of the voice control means to the manufacturer of the vehicle after a very short operating time. In this situation, a serious and technically complex fault diagnosis will have to be carried out by a specialist workshop, which may in the present case also be associated with considerable waiting times for return of the vehicle to the user, since the voice control means are produced using complex electronics and only in extremely rare cases is the specialist workshop qualified to perform a fault diagnosis of these electronics. The manufacturer incurs considerable costs with regard to this fault diagnosis, which the manufacturer cannot pass on to the user within a guarantee period, because the fault diagnosis will not be able to establish any objective malfunctioning and the manufacturer does not want to lose its good public image. However, the user will retain a negative impression, because his with hindsight unnecessary reporting of a fault has caused him difficulties and because he did not have his vehicle freely available for the duration of the fault diagnosis and because the result of the fault diagnosis is not objectively comprehensible to him.

It is an object of the invention to eliminate the above-mentioned problems with regard to a device of the type described above in the first paragraph and to provide an improved device.

To achieve the above-described object with regard to a device of the type described above in the first paragraph, provision is made according to the invention for test means which are designed to test a functioning of the voice control means.

To achieve the above-mentioned object, features according to the invention are provided for a method of the type described above in the second paragraph, so that such a method may be characterized in the following way, namely:

A method of controlling at least one controllable constructed part of a device, which method comprises the following steps, namely voice-actuated control of the at least one device part by means of voice control means, which voice control means are designed to control the at least one device part by means of a receivable acoustic signal, characterized in that functioning of the voice control means is tested by test means.

By providing the measures according to the invention, it is advantageously achieved that, despite possible difficulties with voice-actuated control of parts of the device, reporting of inadequate functioning or even malfunctioning of the voice control means of the device which may with hindsight be deemed unnecessary may be reliably avoided, thereby preventing additional difficulties for a user of the device. By providing the measures according to the invention, it is also advantageously ensured that the manufacturer of a device does not incur costs during a guarantee period for unnecessary fault diagnosis of properly functioning voice control means of the device, which costs would have to be borne by the manufacturer itself because it cannot pass them onto a customer. The advantage is thereby additionally achieved that the device is designed for independent testing of the functioning of its voice control means without the involvement of an expert. The advantage is thereby additionally achieved that testing of functioning of the voice control means may be initiated and performed by a user with any desired frequency and under any desired environmental conditions. In this way, a user may be convinced to the maximum possible degree of the serviceability of the voice control means, whereby the user is also prompted to trace the apparently inadequate functioning or malfunctioning of the voice control means, which he notes during use of the device but which is merely subjective and not objective, back to his own incorrect action and possibly to improve how he uses the voice control means.

In the case of a device according to the invention as claimed in claim 2, the advantage is achieved that individual components of the voice control means may also be tested.

In the case of a device according to the invention as claimed in claim 3, the advantage is achieved that testing of the functioning of the voice control command processing means may be performed independently of testing of the functioning of the voice input means.

In the case of a device according to the invention as claimed in claim 4, the advantage is achieved that testing of the functioning of the voice input means may be performed independently of the testing of the functioning of the voice control command processing means.

In the case of a device according to the invention as claimed in claim 5 and in the case of a method according to the invention as claimed in claim 31, the advantage is achieved that a precisely definable test signal may be fed to the voice control means for testing the functioning thereof.

In the case of a device according to the invention as claimed in claim 6, the advantage is achieved that testing of the voice control means may also be performed in the case of a device which is subject to certain limitations with regard to its ability to communicate with its environment, as is the case for example when the device consists of an electric razor or a microwave oven, since these devices extremely seldom comprise a loudspeaker or a display or an interface.

In the case of a device according to the invention as claimed in claim 7, the advantage is achieved that the test means are independent of the voice control means for controlling the at least one device part, whereby the flexibility of the test means may be extended in the simplest possible way.

In the case of a device according to the invention as claimed in claim 8, the advantage is achieved that, even in the case of a device with controllable device parts which may be extended or interchanged in modular manner and in the case of fundamentally different voice control commands for different device parts, it is always ensured that the correct test signal may be fed to the voice control means during testing of the functioning of the voice control means.

In the case of a device according to the invention as claimed in claim 9, the advantage is achieved that, to feed the test signal to the voice control means, a standard compact disk (CD) or a digital versatile disk (DVD) may be used, whereby the most extensive possible tests may also be performed with respect to functioning of the voice control means. The advantage is further achieved thereby that the test signal, adapted to the various areas of use of the device, may be made available in the simplest possible manner for testing the functioning of the voice control means of the device, as may be required for example when the device is used in different language regions. In this way, the advantage is further achieved that the test signal may also be fed to the voice control means by a hard disk incorporated as a part of the device. It has further proven extremely advantageous in this context for the device part to be designed to access a removable hard disk, because quick testing of the voice control means on the spot by a user or testing of the functioning of the voice control means in a specialist workshop may thereby be performed as simply as possible. The advantage is further achieved thereby that extremely robust smart cards may also be used for the purpose of testing the functioning of the voice control means, which has proven advantageous especially in connection with the use of the device under inhospitable environmental conditions, such as for example in a mine or during space travel.

In the case of a device according to the invention as claimed in claim 10 and in the case of a method according to the invention as claimed in claim 32, the advantage is achieved that the user may be given a demonstration of testing of the functioning of the voice control means.

In the case of a device according to the invention as claimed in claim 11, the advantage is achieved that, in connection with testing of the functioning of the voice control means, the test signal may be transmitted via a data network to the device, wherein it has proven particularly advantageous for the at least one device part to be designed to receive the receive data from the Internet. It may further be mentioned in this context that it has proven particularly advantageous for the at least one device part to be designed to receive data with the aid of a radio wave, if the device is a device suitable for mobile use, as is the case, for example, with a personal digital assistant (PDA) or a cell phone.

In the case of a device according to the invention as claimed in claim 12, the advantage is achieved that evaluation of a result of testing of the functioning of the voice control means may also be performed by the test means.

In the case of a device according to the invention as claimed in claim 13, the advantage is achieved that the test result information may also be further processed by the at least one device part.

In the case of a device according to the invention as claimed in claim 14, the advantage is achieved that the test result information may be output by the device. The advantage is thereby further achieved that the test result information may also be made accessible to a service unit spatially separate from the device. The transmit data may be transmitted on the one hand by means of a line-connected data network, such as the Internet for example. Data transmission may additionally be performed by means of a radio wave, as is the case for example with the transmission of transmit data by means of a cell phone.

In the case of a device according to the invention as claimed in claim 15, the advantage is achieved that the test result information may be made visually accessible to a user of the device.

In the case of a device according to the invention as claimed in claim 16, the advantage is achieved that the test result information may be made acoustically accessible to a user of the device.

In the case of a device according to the invention, an electrical test signal may be fed to the voice control means for example inside the device. In the case of a device according to the invention, it has proven particularly advantageous, however, to provide the measures as claimed in claim 17. In this way, the advantage is achieved that functioning of the voice control means may be tested unambiguously in its entirety. In this way, the advantage is further achieved that a user of the device may be actively involved in testing of the functioning of the voice control means by hearing the output acoustic signal and may be objectively convinced of the actual serviceability of the device. In this way, the advantage is further achieved that a user of the device may, with the aid of the acoustic signal output by the device and constituting the test signal, correct the way he behaves when attempting voice-actuated control of the at least one device part of the device.

In the case of a device according to the invention as claimed in claim 18, the advantage is achieved that the acoustic receiving means of the voice input means may be tested separately.

In the case of a device according to the invention as claimed in claim 19, the advantage is achieved that the echo suppression means of the voice input means may be tested separately.

In the case of a device according to the invention as claimed in claim 20, the advantage is achieved that the voice control command recognition means of the voice input means may be tested separately.

In the case of a device according to the invention as claimed in claim 21, the advantage is achieved that testing of the functioning of the acoustic receiving means, together with the functioning of the echo suppression means, may be performed independently of the functioning of the voice control command recognition means.

In the case of a device according to the invention as claimed in claim 22, the advantage is achieved that testing of the functioning of the echo suppression means, together with the functioning of the voice control command recognition means, may be performed independently of the functioning of the acoustic receiving means.

In the case of a device according to the invention as claimed in claim 23, the advantage is achieved that the test means are designed for reliable, completely autonomous generation of the test signal at any desired time.

In the case of a device according to the invention, the test means may be designed to test the functioning of non-trainable voice control command recognition means. It has proven particularly advantageous, however, to provide the measures as claimed in claim 24. In this way, the advantage is achieved that testing of the functioning of the voice control command recognition means may also be performed in the case of voice control command recognition means adaptable to a user of the device.

In the case of a device according to the invention as claimed in claim 25, the advantage is achieved that, in the case of voice control command recognition means adapted to a user of the device, testing of the functioning of the voice control command recognition means may be performed on the basis of the voice control commands which it has currently been trained to recognize.

In the case of a device according to the invention as claimed in claim 26, the advantage is achieved that testing of the functioning of the voice control command recognition means may be performed independently of adaptations undertaken by a user of the device and on the basis of an original setting of the voice control command recognition means. In this way, the advantage is further achieved that any incorrect adaptations of the voice control command recognition means which may have been effected by a user, which incorrect adaptations may possibly lead to malfunctioning of the voice control command recognition means, may be bypassed during testing of the functioning of the voice control command recognition means. In this way, the advantage is further achieved that, even in the case of trainable voice control command recognition means, testing of the functioning of the voice control command recognition means may provide the user with an objective result.

In the case of a device according to the invention as claimed in claim 27, the advantage is achieved that precise classification of the testing of the functioning of the voice control means, such as for example “voice control means function” or “voice control means do not function”, may be generated by means of the test means.

In the case of a device according to the invention as claimed in claim 28, the advantage is achieved that the device is designed for autonomous storage of the comparison information data.

In the case of a device according to the invention as claimed in claim 29, the advantage is achieved that, if the device part is designed to access memory means, the comparison information data may be fed to the test means by means of the stored data stored in the memory means, or that, if the device part is designed to receive data, the comparison signal may be fed to the test means by means of the receive data received during reception.

The invention will be further described with reference to three examples of embodiment shown in the drawings, to which, however, the invention is not restricted.

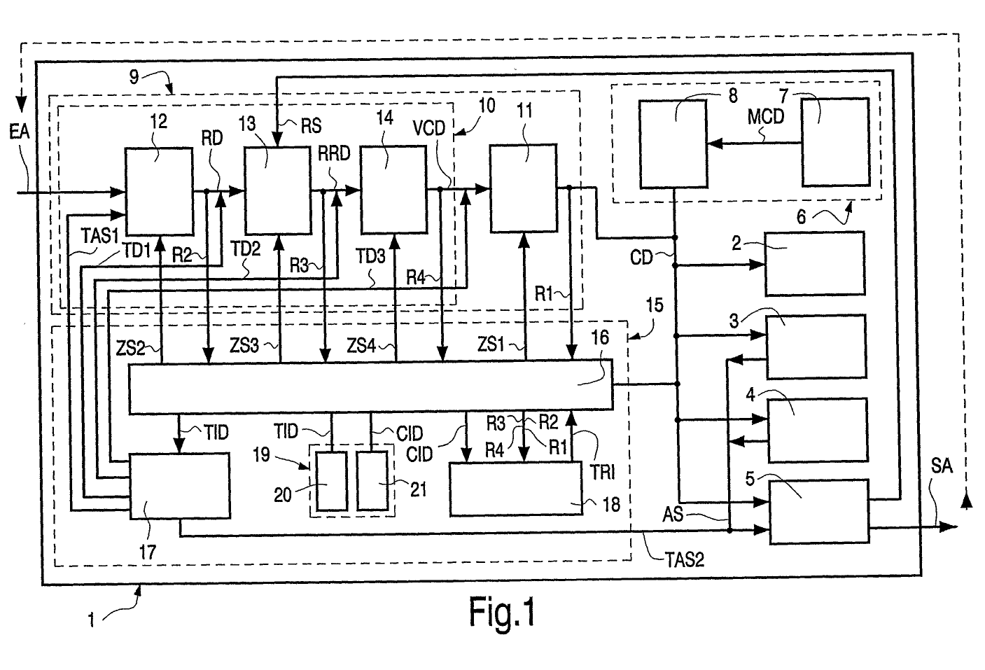

FIG. 1 is a schematic representation, in the form of a block diagram, of a device according to a first example of embodiment of the invention.

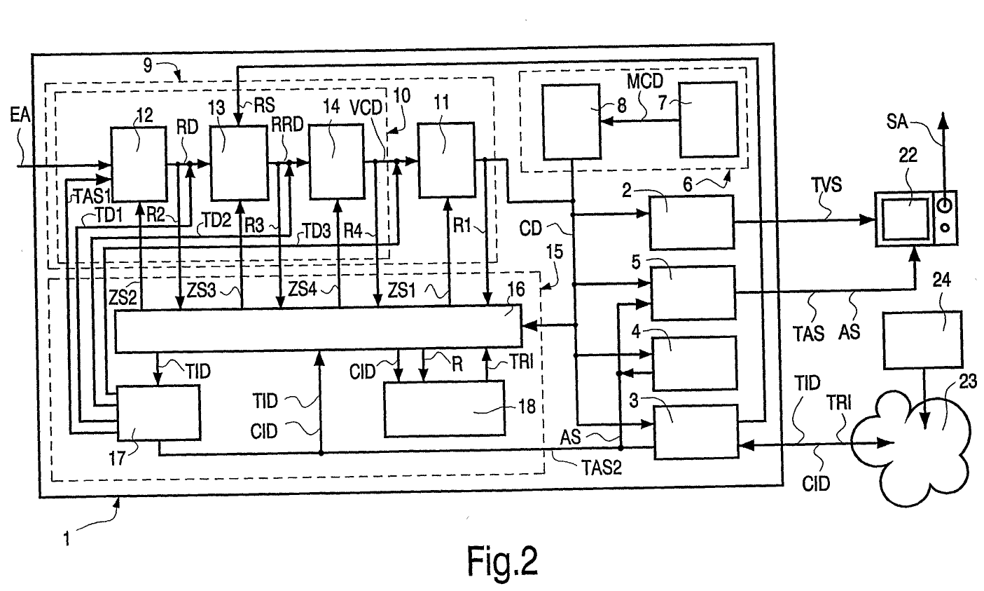

FIG. 2 is a schematic representation, in the form of a block diagram, of a device according to a second example of embodiment of the invention.

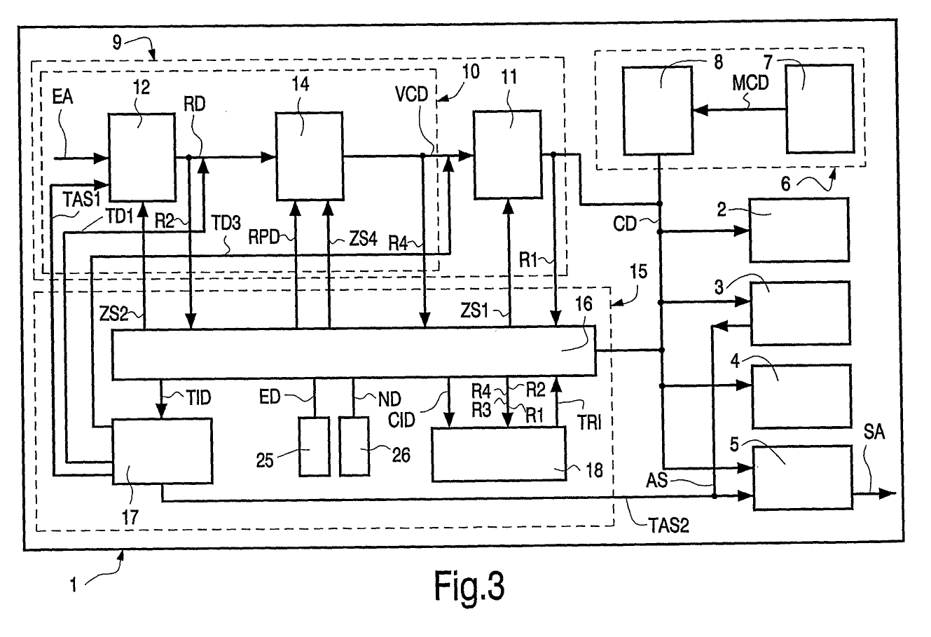

FIG. 3 is a schematic representation, in the form of a block diagram, of a device according to a third example of embodiment of the invention.

FIG. 1 shows a device 1 consisting of a compact audio system. The device 1 comprises at least one controllable device part, namely a first device part 2 and a second device part 3 and a third device part 4 and a fourth device part 5. The first device part 2 takes the form of a vacuum fluorescent display. The second device part 3 takes the form of a radio receiver. The third device part 4 takes the form of a compact disk player module. The fourth device part 5 consists of acoustic signal generating means for generating and outputting an acoustic signal SA from the device 1 and comprises a pre-amplifier, not shown in FIG. 1, and an output amplifier and a loudspeaker. The four device parts 2, 3, 4 and 5 are each designed to receive control data CD, wherein each of the four device parts 2, 3, 4 and 5 is designed to be controllable by means of the control data CD relative to its individual function.

The device 1 further comprises manual control means 6, which are designed for manually actuated control of the four device parts 2, 3, 4 and 5. To this end, the manual control means 6 comprise manual input means 7, which take the form of a control button module, so that a user of the device 1 may control at least one of the four device parts 2, 3, 4 and 5 manually by manual actuation of buttons on the control button module. The manual input means 7 are designed to output manual control command data MCD in response to manual actuation. The manual control means 6 further comprise manual control command processing means 8, which are designed to receive the manual control command data MCD and to generate and output control data CD, which control data CD correspond to the respective manual control command data MCD and are provided to control the four device parts 2, 3, 4 and 5. Accordingly, in the case of the first device part 2 for example, individual display elements of the vacuum fluorescent display may be activated or deactivated as a function of the received control data CD. Accordingly, in the case of the second device part 3, it is further possible to switch a receiving frequency of the radio receiver over to receive different radio broadcasts as a function of the received control data CD. Accordingly, in the case of the third device part 4, it is further possible to start or stop playback of a compact disk or to select different pieces of music as a function of the received control data CD. Accordingly, in the case of the fourth device part 5, it is further possible to change the strength, i.e. the volume, of the acoustic signal SA that can be output by the device 1 or the pitch of the acoustic signal SA that can be output as a function of the received control data CD.

The device 1 further comprises voice control means 9, which are designed for voice actuated control of the four device parts 2, 3, 4 and 5. The voice control means 9 comprise voice input means 10 and voice control command processing means 11.

The voice input means 10 are designed to receive an acoustic signal EA and, if at least one voice control command is recognizable in the received acoustic signal EA, to generate and output to the voice control command processing means 11 voice control command data VCD corresponding to the recognizable voice control command.

The voice control command processing means 11 take the form of a microprocessor and software suitable for producing the voice control command processing means 11 and are designed to receive and process the voice control command data VCD and to generate and output the control data CD corresponding to the voice control command data VCD which control data CD are used for controlling the four device parts 2, 3, 4 and 5. The voice control command processing means 11 are further designed to receive a first state control signal ZS1. The voice control command processing means 11 are so designed as to be capable of being brought into a deactivated state or into an activated state as a function of the first state control signal ZS1, while no control data CD may be output in the deactivated state.

The voice input means 10 comprise acoustic receiving means 12 for the purpose of receiving the acoustic signal EA, which receiving means 12 take the form of a microphone (not shown in FIG. 1) and a microphone amplifier and an analog/digital converter. The acoustic receiving means 12 are further designed to output receive data RD, which constitute a digital representation of the second acoustic signal A2. The acoustic receiving means 12 are further designed to receive a second state control signal ZS2. The acoustic receiving means 12 are so designed as to be capable of being brought into a deactivated state or into an activated state as a function of the second state control signal ZS2, while no receive data RD may be output in the deactivated state.

The voice input means 10 further comprise echo suppression means 13, which are designed to suppress the output audio signal SA, self-generated by means of the fourth device part 5, in the acoustic signal EA received by the voice input means 10. For the purpose of suppression, the echo suppression means 13 are designed to receive a suppression signal RS representing the output acoustic signal SA, which suppression signal RS may be output by the fourth device part 5. The echo suppression means 13 are further designed to generate and output echo-free receive data RRD as a consequence of suppression of the self-generated output acoustic signal SA. The echo suppression means 13 are further designed to receive a third state control signal ZS3. The echo suppression means 13 are so designed as to be capable of being brought into a deactivated state or into an activated state as a function of the third state control signal ZS3, while no echo-free receive data RRD may be output in the deactivated state. In the activated state, the echo suppression means 13 are so designed as to be capable of being brought into a neutral state by means of the third state control signal ZS3, while in the neutral state the receive data RD may be output as the echo-free receive data RRD. The echo suppression means 13 take the form of a digital signal processor (DSP).

The voice input means 10 further comprise voice control command recognition means 14, which are designed to recognize at least one voice control command in the receivable acoustic signal EA. The voice control command recognition means 14 are designed to generate and output the voice control command data VCD corresponding to the recognizable voice control command, if at least one voice control command is recognizable in the received acoustic signal EA. The voice control command recognition means 14 take the form of software which may be run on a microprocessor. The voice control command recognition means 14 comprise phoneme memory means, not shown in FIG. 1, in which phoneme memory means is stored a phoneme sequence corresponding to each recognizable voice control command and typical of the respective voice control command for the purpose of recognizing the voice control command in the echo-free receive data RRD. The phoneme sequences have been generated by means of a hundred individuals representative of a particular language and the voice control means 9 are not designed to change these phoneme sequences. The voice control command recognition means 14 are further designed to receive a fourth state control signal ZS4. The voice control command recognition means 14 are so designed as to be capable of being brought into a deactivated state or into an activated state, while no voice control command data VCD may be output in the deactivated state.

The voice input means 10 are designed to be deactivatable in the event that the acoustic receiving means 12 and the echo suppression means 13 and the voice control command recognition means 14 are brought as a group into their deactivated state, so that no voice control command data VCD may be output to the voice control command processing means 11 by the voice input means 10.

According to the invention, the device 1 comprises test means 15, which are designed to test the functioning of the voice control means 9. The test means 15 comprise test control means 16, test signal generating means 17, comparison means 18 and test memory means 19 and take the form of the microprocessor and software suitable for providing the test means 15.

The test control means 16 are designed to control testing of the functioning of the voice control means 9. The test control means 16 are designed to this end to receive the control data CD, which may be generated by means of the manual control means 6. The test control means 16 are designed to start testing and stop testing by means of the receivable control data CD. The test control means 16 are further designed to generate during testing the control data CD for controlling the four device parts 2, 3, 4 and 5, so that, even during testing, display of display information may be performed by means of the first device part 2 or a variation in the volume or pitch of the acoustic signal SA that can be output by means of the fourth device part 5.

For the purpose of controlling the testing, the test control means 16 are further designed to generate and output the four state control signals ZS1, ZS2, ZS3 and ZS4. By means of the test control means 16, the acoustic signal receiving means 12, the echo suppression means 13 and the voice control command recognition means 14 may be brought into their deactivated state and the voice control command processing means 11 into their activated state, so that the test means 15 are designed to deactivate the voice input means 10 and to test the voice control command processing means 11 in a manner unaffected by the voice input means 10. This defines a first test mode. In addition, the test control means 16 are designed to bring the acoustic signal receiving means 12, the echo suppression means 13 and the voice control command recognition means 14 into their activated state and to bring the voice control command processing means 11 into their deactivated state, so that the test means 15 are designed to deactivate the voice control command processing means 11 and to test the voice input means 10 in a manner unaffected by the voice control command processing means 11. This defines a second test mode. Accordingly, the test means 15 are designed to test functioning of the voice input means or to test functioning of the voice control command processing means 11. However, by means of the test control means 16, the acoustic receiving means 12, the echo suppression means 13, the voice control command recognition means 14 and the voice control command processing means 11 may also be brought simultaneously into their activated state. This defines a third test mode. Accordingly, the test means 15 are designed to test functioning of the voice input means 10 and to test functioning of the voice control command processing means 11. However, by means of the test control means 16, it is also possible for solely the acoustic receiving means 12 to be brought into its activated state and the means 13, 14 and 11 to be brought into their deactivated state, whereby the test means 15 are designed to test functioning of the acoustic receiving means 12. This defines a fourth test mode. Furthermore, it is also possible for solely the echo suppression means 13 to be brought into their activated state by means of the test control means 16, while the means 12, 14 and 11 may be brought into their deactivated state, whereby the test means 15 are designed to test functioning of the echo suppression means 13. This defines a fifth test mode. Furthermore, it is also possible for solely the voice control command recognition means 14 to be brought into their activated state by means of the test control means 16, while the means 12, 13 and 11 may be brought into their deactivated state, whereby the test means 15 are designed to test functioning of the voice control command recognition means 14. This defines a sixth test mode. Furthermore, by means of the test control means 16, the acoustic receiving means 12 and the echo suppression means 13 may be brought into their activated state and the voice control command recognition means 14 into their deactivated state, so that the test means 15 are designed for combined testing of the functioning of the acoustic receiving means 12 together with the echo suppression means 13. This defines a seventh test mode. Furthermore, by means of the test control means 16, the echo suppression means 13 and the voice control command recognition means 14 may be brought into their activated state and the acoustic receiving means 12 and the voice control command processing means 11 into their deactivated state, so that the test means 15 are designed for combined testing of the functioning of the echo suppression means 13 together with the voice control command recognition means 14. This defines an eighth test mode.

For the purpose of controlling the testing, the test control means 16 are further designed to receive first result data R1, second result data R2, third result data R3 and fourth result data R4, wherein the control data CD that can be output by the voice control command processing means 11 form the first result data R1, wherein the receive data RD form the second result data R2, wherein the echo-free receive data RRD form the third receive data R3 and wherein the voice control command data VCD form the fourth result data R4. The test control means 16 are further designed to output the four result data R1, R2, R3 and R4 to the comparison means 18. The test control means 16 are further designed to access the test memory means 19 and at the same time to receive test information data TID and comparison information data CID. The test control means 16 are further designed to output test information data TID to the test signal generating means 17 and to output the comparison information data CID to the comparison means 18.

The test control means 16 are further designed to receive test result information data TRI from the comparison means 18. In the case of reception of the test result information data TRI, the test control means 16 are further designed to generate the control data CD for controlling the first device part 2, wherein the control data CD comprise the display information for the first device part 2, which display information represents at least in part the test result information. In this context, it may also be mentioned that the test control means 16 may be designed to generate an audio signal AS on reception of the test result information data TRI, which audio signal AS may be output to the fourth device part 5 and that can be output by the fourth device part 5 as the acoustic signal SA, so that the output acoustic signal SA represents at least in part the test result information. In this case, the output acoustic signal SA may for example represent a sentence audible to a user, namely “The test has been successfully completed” or “The test has failed”.

The test memory means 19 comprise test information memory means 20 and comparison information memory means 21. The test information memory means 20 are designed to store test information, wherein the test information is provided to generate a test signal and wherein, in the event of the test control means 16 accessing the test memory means 19, the test information may be output as the test information data TID to the test control means 16. The comparison information memory means 21 are designed to store comparison information, wherein the comparison information is provided as a basis for comparison with the result data R1, R2, R3 and R4 and wherein, in the event of the test control means 16 accessing the test memory means 19, the comparison information may be output as the comparison information data CID to the test control means 16. The test information and the comparison information form an information pair, which information pair comprises the information necessary for testing functioning of the voice control means 9 for all test modes.

The test signal generating means 17 are designed to generate and output a first test audio signal TAS1 to the acoustic receiving means 12 with the aid of the test information data TID. The test signal generating means 12 are further designed to generate and output first test data TD1 to the echo suppression means 13 in the form of receive data RD with the aid of the test information data TID. The test signal generating means 17 are further designed to generate and output second test data TD2 to the voice control command recognition means 14 in the form of echo-free receive data RRD with the aid of the test information data TID. The test signal generating means 17 are further designed to generate and output third test data TD3 to the voice control command processing means 11 in the form of voice control command data VCD with the aid of the test information data TID. The test signal generating means 17 are further designed to generate and output a second test audio signal TAS2 to the fourth device part 5 with the aid of the test information data TID, wherein the acoustic signal SA may be generated and output by the fourth device part 5 on the basis of the second test audio signal TAS2 and received by the voice control means 9 as the acoustic signal EA. Accordingly, a test signal may be fed to the voice control means 9 via the test means 15, wherein the test signal either takes the form of the first test audio signal TAS1 or the received acoustic signal EA or the first test data TD1 or the second test data TD2 or the third test data TD3. In the case of the first test audio signal TAS1 and the first test data TD1 and the second test data TD2 and the third test data TD3, the test means 15 are designed for autonomous generation of the test signal. In the case of the output acoustic signal SA generated by means of the second test audio signal TAS2, which acoustic signal SA may be fed to the voice control means 9 as the received acoustic signal EA forming the test signal, the test signal may be fed to the voice control means 9 via the test means 15 as a result of control of the fourth device part 5.

The comparison means 18 are designed to receive the result data R1, R2, R3 and R4 and to receive the comparison information data CID and to compare the result data R1, R2, R3 and R4 with the comparison information data CID. The comparison means 18 are further designed to generate test result information representing the result of the comparison and to output the test result information data TRI representing the test result information to the test control means 16.

Accordingly, the test signal TAS1 or TD1 or TD2 or TD3 or A2 may be fed to the voice control means 9 by means of the test means 15 as a function of the respective test mode. Functioning of the voice control means 9 or functioning of the means 12, 13, 14 or 11 may be tested independently of one another or in combination as a function of the respective test mode. The test means 15 are accordingly further designed to receive the result data R1, R2, R3 or R4, wherein the result data R1, R2, R3 or R4 may be generated by the voice control means 9 in response to the test signal TAS1, TD1, TD2, TD3 or A2 which may be fed to the voice control means 9 by the test means 15. The test means 15 are further designed to generate the test result information with the aid of the result data R1, R2, R3 or R4 and the comparison information.

Functioning of the device 1 will be explained below with reference to an example of application. According to this example of application, it should be assumed that a user of the device 1 utters control commands, in order to control the second device part 3, i.e. the radio receiver, wherein the uttered voice control commands, optionally together with the self-generated output acoustic signal SA, form the received acoustic signal EA receivable by the voice control means 9 of the device 1. In the case of the device 1, a method of controlling one of the four controllable device parts 2, 3, 4 and 5 is consequently applied, in which method voice-actuated control of one of the four device parts 2, 3, 4 and 5 proceeds by means of the voice control means 9. However, the user utters the voice control commands so unclearly that voice-actuated control of the second device part 3 fails. However, the user is unaware of his unclear utterance of the voice control commands and he gains the subjective impression that the device 1 is not responding properly to voice control commands uttered by him. In such a situation, the user starts testing functioning of the voice control means 9 by actuating a button on the manual control means 6 provided for starting testing of the voice control means 9, whereupon, in the case of the method for controlling the four controllable device parts 2, 3, 4 and 5, functioning of the voice control means 9 is tested by means of the test means 15. During testing of functioning of the voice control means 9 by the test means 15, the received acoustic signal EA is fed to the voice control means 9 as the test signal.

To this end, the manual control means 6 first generate the control data CD to start testing. The test control means 16 receive the test control data CD and start testing the functioning of the voice control means 9 according to the third test mode, wherein first of all the voice input means 10 and the voice control command processing means 11 are brought into the activated state by the test control means 16 with the assistance of the four control signals ZS1, ZS2, ZS3 and ZS4.

The test control means 16 then bring the echo suppression means 13 into their neutral state by means of the third state control signal ZS3, so that no suppression of the self-generated output acoustic signal SA is performed by the echo suppression means 13.

The test control means 16 then control the fourth device part 5 by means of the control data CD in such a way that the acoustic signal SA may be output by the fourth device part 5, wherein the output acoustic signal SA exhibits a standard volume and a standard pitch.

The test signal generating means 17 receive the test information data TID and initially generate the second test audio signal TAS2 in accordance with the test information data TID and output this test audio signal TAS2 to the fourth device part 5. The second test audio signal TAS2 represents the word “test”, wherein this word may be recognized by the voice input means 10 as a voice control command. By means of the fourth device part 5, the acoustic signal SA is generated on the basis of the second test audio signal TAS2 and output and heard by the user of the device 1. At the same time, this output acoustic signal SA is received as the acoustic signal EA by means of the acoustic receiving means 12 and is used as the test signal. The acoustic receiving means 12 generate the receive data RD representing the received acoustic signal EA and output these to the echo suppression means 13 brought into the neutral state.

The echo suppression means 13 output the received data RD unaffected to the voice control command recognition means 14 as the echo-free receive data RRD. The voice control command recognition means 14 then recognize the voice control command “test” as such and generate the voice control command data VCD corresponding to this voice control command and output them to the voice control command processing means 11. The voice control command processing means 11 then generate the control data CD, by means of which the word “test” is displayed by the first device part 2. It may be mentioned in this context that, in the event of recognition of a voice control command causing control of one of the four device parts 2, 3, 4 or 5, such as for example “start CD”, playback of a compact disk may be started at the third device part 4 via the suitable control data CD.

At the same time, the four result data R1, R2, R3 and R4 are received by the test control means 16 and output to the comparison means 18. The test control means 16 further access the test memory means 19 in order to retrieve the comparison information data from the test memory means 19 and output them to the comparison means 18. The comparison means 18 then compare the received comparison information data CID with the four result data R1, R2, R3 and R4 and, in the event of correspondence of the comparison information data with the four result data R1, R2, R3 and R4, generate the test result information representing positive completion of testing of the voice control means 9. Upon reception of the test result information data TRI representing this test result information, the test control means 16 generate control data CD for the first device part 2, so that, by means of the first device part 2, display information is displayed which communicates to the user the positive completion of testing. This is performed by display of the words “Acoustic test successfully completed”. In this way, the advantage is achieved that the user may be objectively convinced of the serviceability of the device or the voice control means 9, because he hears the test signal and is himself involved in voice-actuated control of one of the four device parts 2, 3, 4 or 5. In this way, the advantage is further achieved that the user may optimize his own speech behavior on the basis of the test signal heard.

If the test result information data TRI represent a negative test result for the voice control means 9, generation and output of the acoustic signal SA is performed repeatedly, wherein, with each repetition, the fourth device part 5 is controlled by the test control means 16 in such a way, according to a scheme predetermined by the test information data TID, that the output acoustic signal SA exhibits a different volume and/or a different pitch with each repetition, so that the voice control means 9 are tested with output acoustic signals SA which may differ from one another with regard to volume and pitch. With each of these repeated tests, the four result data R1, R2, R3 and R4 are received by the test control means 16 and output to the comparison means 18 for the purpose of comparison with comparison information data CID stored in the test memory means 19. According to the result of the comparison, i.e. according to the test result information data TRI, it may be established via the test control means 16 whether any received data RD of the required quality are being output by the acoustic receiving means 12. It may further be established by the test control means 16 whether the echo-free received data RRD actually match the received data RD. It may further be established by means of the test control means 16 whether, if received data RD of suitable quality are present and if echo-free receive data RRD matching the receive data RD are present, suitable voice control command data VCD are being generated. Accordingly, it may be established relatively accurately by means of the test control means 16 which of the result data R1, R2, R3 and R4 optionally permits a conclusion to be drawn about malfunctioning of the means 12, 13 or 14. It may be mentioned in this connection that, during this testing of the voice control means 9 by the test means 15, it may also be established whether the environmental conditions will allow voice-actuated control at all.

If, for example, the acoustic receiving means 12 are not outputting any received data RD of suitable quality, testing of functioning of the voice control means 9 is performed according to the fourth test mode. The first test audio signal TAS1 is then fed as a test signal to the acoustic receiving means 12 by means of the test control means 16 and the second result data R2 then arising are sent for comparison by means of the comparison means 8. If the test result information does not then indicate successful testing of the functioning of the acoustic receiving means 12, the test control means 15 may conclude that the acoustic receiving means 12 are malfunctioning and communicate this to the user by means of the first device part 2. If the test result information does indicate successful testing of the functioning of the acoustic receiving means 12, the test control means 16 may conclude therefrom that acoustic reception of the acoustic signal EA cannot be performed by means of the acoustic receiving means 12, so that malfunctioning in the area of the microphone may be assumed, which is likewise communicated to the user by means of the first device part 2.

If defective echo-free receive data RRD are detected by means of the comparison means 18, testing of the functioning of the voice control means 9 proceeds according to the fifth test mode. In this instance, received data RD constituting first test data TD1 are generated by means of the test signal generating means 17 and output to the echo suppression means 13. The third result data R3 received by the test control means 16 are then compared with the comparison information data CID by means of the comparison means 18 and the test result information is communicated by the test control means 16 to the user by means of the first device part 2. If the acoustic receiving means 12 and the echo suppression means 13 do not exhibit any malfunctioning, testing of functioning of the voice control means is performed according to the sixth test mode. In this instance, echo-free receive data RRD constituting second test data TD2 are output by means of the test signal generating means 17 to the voice control command recognition means 14. By suitable generation of the third state control signal ZS3, functioning of the echo suppression means 13 is tested in the deactivated, activated and neutral state thereof. The fourth result data R4 received by the test control means 16 are output to the comparison means 18 for the purpose of comparison. The result of the comparison is communicated to the user visually by the test control means 16 by means of the first device part 2. In this context, it has proven particularly advantageous for testing of the voice control means 9 to trigger a demonstration for the user of the device by means of a test signal formed by the received acoustic signal EA—especially when the voice control means 9 of the device 1 are functioning properly. The advantage is further achieved that the user has the option of correcting his own incorrect operation on the basis of the control commands generated by the device 1 itself and output acoustically. In addition, when the voice control means 9 are indeed malfunctioning, extremely precise and quick testing of functioning of the voice input means 10 and functioning of the voice control command processing means 11 may be performed by means of the test means 15, while fault location may proceed as efficiently as possible and appropriate repair measures may be performed in a servicing workshop.

The device 1 illustrated in FIG. 2 consists of a games console. With the device 1 illustrated in FIG. 2, the first device part 2 forms display control means, which are designed to control a television set 22 by means of a display signal TVS which may be generated thereby and output to the television set 22. The fourth device part 5 consists of acoustic signal output means, which are designed to output the audio signal AS and the second test audio signal TAS2 to the television set 22. The television set 22 comprises acoustic signal generating means, by means of which the audio signal AS and the second test audio signal TAS2 may be converted into the acoustic signal SA and output by the television set 22.

In contrast to the device 1 illustrated in FIG. 1, the device 1 illustrated in FIG. 2 does not comprise a test memory means 19. However, the second device part 3 consists of network communication means, which are designed to communicate data over a network 23 connectable to the device 1. In the present case, the network 23 takes the form of the Internet. However, it may be mentioned in this connection that the network 23 may also take the form of a Local Area Network or a Wide Area Network or take the form of a radio-based network, and that the second device part 3 may be designed accordingly.

A service unit 24 may be connected to the network 23, by means of which unit 24 the test information data TID and the comparison information data CID may be communicated to the device 1 over the network 23. The test information data TID and the comparison information data CID may be received by means of the second device part 3 as receive data during communication with the network 23. Accordingly, the second device part 3 is designed to receive data, wherein the received data represent at least in part the test signal. The second device part 3 is further designed to output the test information data TID and the comparison information data CID to the test control means 16, so that testing of the functioning of the voice control means 9 may be performed by means of the test control means 16 on the basis of the test information data TID and on the basis of the comparison information data CID. The result of this testing, namely the test result information data TRI, may be output by means of the test control means 16 as a component of the control data CD to the second device part 3 in the event of the control of the second device part 3 by means of the control data CD. By means of the second device part 3, the test result information data TRI may be output to the network 23 as transmit data in the event of communication with the network 23 and fed via the network 23 to the service unit 24. Accordingly, the second device part 3 is designed to transmit data, wherein, upon transmission, the transmit data represent at least in part the test result information. Consequently, remote-controllable testing of the functioning of the voice control means 9 may be performed by means of the test means 15.

It may be mentioned that, in the case of suitable test information data TID, the test signal generating means 17 may be dispensed with. This is the case when the test information data TID already exhibit the first test data TD1 or the second test data TD2 or the third test data TD3, so that these test data TD1, TD2 or TD3 may be directly output by the test control means 16. It may furthermore be mentioned in this connection that the test information data TID may also exhibit the second test audio signal TAS2. This is particular sensible when the fourth device part 5 consists of audio signal output means, which are designed to receive a digital audio signal AS or TAS2.

It may further be mentioned that the comparison means 18 may be omitted from the test means 15. In this connection, it may further be mentioned that the test control means 16 may be designed to output the respective result data R1, R2, R3 or R4 to the second device part 3 as a constituent of the control data CD. By means of the second device part 3, the respective result data R1, R2, R3 or R4 may be communicated as transmit data over the network to the service unit 24. In this way, it is advantageously achieved that the test means 15 are of the simplest possible construction and that generation and provision of test information data TID representing the test signal and comparison of the result data R1, R2, R3 or R4 may be performed wholly by means of the service unit 24.

The third device part 4 is designed to access optically readable memory means, such as for example a compact disk (CD) or a digital versatile disk (DVD). The data stored on the optical memory means represent pieces of music and/or video films or the test signal. Thus, it is possible for testing of the voice control means 9 to be initiated or commented on or accompanied by an acoustic or visual signal. However, the stored data may also comprise the test information data TID and the comparison information data CID. Accordingly, the data stored in the memory means at least in part represent the test signal.

The test means 15 are designed to control the third device part 4, so that, by means of the test means 15, the test signal may be fed to the voice control means as a result of control of the third device part 4. The test information data TID and the comparison information data CID may likewise be retrieved from the memory means as a result of control of the third device part 4 and output to the test control means 16.

In this way, the advantage is achieved that testing of functioning of the voice control means 9 may be performed even in the event of the absence of a connection to the network 23.

It may be mentioned that the device 1 may also comprise an Internet audio device, in which the first device part 2 and the third device part 4 are not provided and which may be designed to receive audio data over the Internet and to output these audio data, which audio data represent the audio signal AS or the second test audio signal TAS2, as the acoustic signal SA.

The device 1 illustrated in FIG. 3 consists of a vehicle. In the device 1 illustrated in FIG. 3, the first device part 2 takes the form of a navigation device. The second device part 3 takes the form of a cell phone. The third device part 4 comprises an air-conditioning system. The fourth device part 5 comprises a hi-fi audio playback device, which is designed to generate and output the acoustic signal SA, so that the output acoustic signal SA is principally audible within the device 1. The voice control means 9 comprise the acoustic receiving means 12, which comprise a directional microphone on the input side for receiving the acoustic signal EA. In contrast to the device illustrated in FIG. 1, with the device 1 illustrated in FIG. 3 no echo suppression means 13 are provided, because the acoustic receiving means 12 are provided with the directional microphone. The voice control means 9 further comprise the voice control command recognition means 14, which are designed directly to receive the data RD.

The voice control command recognition means 14 are designed to be trainable by a user of the device 1 with regard to a speech characteristic of the user and with regard to a number of voice control commands that can be used by the user. The voice control command recognition means 14 are designed to modify phoneme data necessary for recognition of a voice control command during training on the basis of the received data RD, wherein the modified phoneme data are stored as user phoneme data by the voice control command recognition means 14. The test means 15 are designed to test functioning of the trainable voice control command recognition means 14.

To this end, the test means 15 comprise training data memory means 25 and reference data memory means 26. The training data memory means 25 are intended to store training data ED, wherein the training data ED may be generated during training of the voice control command recognition means 14 at least in part from the received acoustic signal EA. During training of the voice control command recognition means 14, the user may select by means of the manual control means 6 the voice control command for which he wishes to effect training, which voice control command may be displayed visually as a word by means of a screen of the first device part 2. An acoustic signal EA that can be generated by the user upon utterance of the voice control command may then be received by the acoustic receiving means 12. The received data RD that can be generated by means of the acoustic receiving means 12 may be received by the test control means 16 and stored as user receive data in the training data memory means 25 as a component of the training data ED. In addition, the user voice control command data corresponding to the respective voice control command and the user control data corresponding to the respective voice control command may be stored by the test control means 16 in the training data memory means 25 as a component of the training data ED. During testing of the voice control means 9, the user receive data may be retrieved from the training data memory means 25 by means of the test control means 16 as a component of the training data ED and output to the test signal generating means 17 as a component of the test information data TID. The test signal generating means 17 are designed, on the basis of the user receive data, to generate and output the first test audio signal TAS1 to the acoustic receiving means 12 or the first test data TD1 to the voice control command recognition means 14 or the second test audio signal TAS2 to the fourth device part 5. The test control means 16 are further designed to control the fourth device part 5, so that, by means of the test means 15, the test signal may, as a result of control of the fourth device part 5, be fed to the voice control means 9 as the output acoustic signal SA forming the received acoustic signal EA. The first result data R1 or second result data R2 or fourth result data R4 receivable by means of the test control means during testing of the voice control means 9 may be fed to the comparison means 18. The test control means 16 are further designed to output the comparison information data CID to the comparison means 8, wherein the comparison information data CID may be retrieved from the training data memory means 25 by means of the training data ED, namely as user receive data or user voice control command data or user control data. Accordingly, the test means 15 are designed to test functioning of the trainable voice control command recognition means 14 with the aid of the training data ED.

The reference data memory means 26 are designed to store reference data ND, wherein the reference data ND may be generated at least in part by means of the original acoustic signals and which original acoustic signals comprise voice control commands which may be recognized by the voice control command recognition means 15 at the time of delivery of the device 1 to a user. The reference data ND in this connection comprise reference receive data, which may be formed from the receive data RD. The reference data ND further comprise reference voice control command data and reference control data for each verbally generatable voice control command. The reference data ND further comprise reference phoneme data for each voice control command that can be generated verbally. The test control means 16 are designed to access the reference receive data forming a component of the reference data ND and to output the reference receive data to the test signal generating means 17 as a component of the test information data TID, whereby the test signal may be generated by means of the test signal generating means 17 to test the functioning of the voice control means 9. The test control means 16 are further designed to access the reference phoneme data forming a component of the reference data ND and to output the reference phoneme data to the voice control command recognition means 14, wherein the reference phoneme data replace the user phoneme data during testing. The test control means 16 are further designed to access the reference voice control command data forming a component of the reference data ND or the reference control data, which, together with the reference receive data, may be output to the comparison means 18 as the comparison information data CID. Accordingly, the test means 15 are designed to test functioning of the voice control command recognition means 14 with the aid of the reference data ND.

It may be mentioned that during the testing of the voice control means 9 the control data CD generatable by the test control means 16 may be used to control one of the controllable device parts 2, 3, 4 or 5, so that the training data ED may be stored on optically, magnetically or electrically writeable memory means and so that the reference data ND may also be retrieved from optically, magnetically or electrically readable memory means.

It may be mentioned that the test means 15 may also comprise an amplifier and a loudspeaker, so that the test means 15 may also be designed to generate the audible test signal in the form of the received acoustic signal EA independently of the device parts 2, 3, 4 or 5 of the device 1.

It may be mentioned that, in the case of a device 1, which does not comprise any loudspeaker for outputting the acoustic signal SA, acoustic testing of the voice control means may be performed if, for example, the components of the test signal generating means 17 designed to generate the acoustic test signal are components of a test apparatus equipped with a test loudspeaker or connectable to such a test loudspeaker. It may further be mentioned in this connection that the test signal generating means 17 of the device 1 may also be designed for direct connection to such a test loudspeaker arranged externally relative to the device 1.

1. A device (1) having at least one controllable device part (2, 3, 4, 5), which device comprises voice control means (9) which are designed for voice-actuated control of the at least one device part (2, 3, 4, 5), characterized in that test means (15) are provided which are designed to test a functioning of the voice control means (9).

2. A device (1) as claimed in claim 1,
in which the voice control means (9) comprise voice input means (10) which are designed to receive an acoustic signal (EA) and, if at least one voice control command is recognizable in the received acoustic signal (EA), to generate and output voice control command data (VCD) corresponding to the recognizable voice control command, and
in which the voice control means (9) comprise voice control command processing means (11) which are designed to process the voice control command data (VCD) and to generate and output control data (CD) corresponding to the voice control command data (VCD) for controlling the at least one device part (2, 3, 4, 5), characterized in that the test means (15) are designed to test the functioning of the voice input means (10) and/or to test the functioning of the voice control command processing means (11).

3. A device (1) as claimed in claim 2, characterized in that the voice input means (10) can be deactivated and in that the test means (15) are designed to deactivate the voice input means (10).

4. A device (1) as claimed in claim 2, characterized in that the voice control command processing means (11) can be deactivated and in that the test means (15) are designed to deactivate the voice control command processing means (11).

5. A device (1) as claimed in claim 1, characterized in that a test signal (TAS1, TD1, TD2, TD3, EA) may be fed to the voice control means (9) by the test means (15).

6. A device (1) as claimed in claim 5, characterized in that the test means (15) are designed for autonomous generation of the test signal (TAS1, TD1, TD2, TD3, EA).

7. A device (1) as claimed in claim 5, characterized in that the test means (15) are designed to control the at least one device part (2, 3, 4, 5).

8. A device (1) as claimed in claim 7, characterized in that the test signal (TAS1, TD1, TD2, TD3, EA) may be fed to the voice control means (9) by the test means (15) as a result of control of the at least one device part (2, 3, 4, 5).

9. A device (1) as claimed in claim 8, characterized in that the at least one device part (2, 3, 4, 5) is designed to access optically, magnetically or electrically readable memory means, wherein data stored in the memory means at least in part represent the test signal (TAS1, TD1, TD2, TD3, EA).

10. A device (1) as claimed in claim 5, characterized in that an output acoustic signal (SA) forms the test signal (EA).

11. A device (1) as claimed in claim 8, characterized in that the at least one device part (3) is designed to receive data, wherein the receive data at least in part represent the test signal (TAS1, TD1, TD2, TD3, EA).

12. A device (1) as claimed in claim 1, characterized in that the test means (15) are designed to receive result data (R1, R2, R3, R4), wherein the result data (R1, R2, R3, R4) may be generated by the voice control means (9) in response to the test signal (TAS1, TD1, TD2, TD3, EA) which may be fed to the voice control means (9) by the test means (15), and
in that the test means (15) are designed to generate test result information representing the result data (R1, R2, R3, R4).

13. A device (1) as claimed in claims 7 and 12, characterized in that the test means (15) are designed to output the test result information to the at least one device part (2, 3, 4, 5).

14. A device (1) as claimed in claim 13, characterized in that the at least one device part (3) is designed to transmit data, wherein the transmit data at least in part represent the test result information.

15. A device (1) as claimed in claim 13, characterized in that the at least one device part (2) is designed to display information, wherein the display information at least in part represents the test result information.

16. A device (1) as claimed in claim 13, characterized in that the at least one device part (5) is designed to output an acoustic signal (SA), wherein the output acoustic signal (SA) at least in part represents the test result information.

17. A device (1) as claimed in claim 8, characterized in that the at least one device part (5) is designed to output an acoustic signal (SA), wherein the output acoustic signal (SA) forms the test signal (EA).

18. A device (1) as claimed in claim 2, in which the voice input means (10) comprise acoustic receiving means (12) which are designed to receive the acoustic signal (EA) and to generate and output receive data (RD) representing the received acoustic signal (EA), characterized in that the test means (15) are designed to test the functioning of the acoustic receiving means (12).

19. A device (1) as claimed in claim 2, in which the voice input means (10) comprise echo suppression means (13) which are designed to suppress an acoustic signal self-generated by means of the device (1) or by means of least one device part (2, 3, 4, 5) and received by the voice input means (10) and which are designed to generate echo-free receive data (RRD), characterized in that the test means (15) are designed to test functioning of the echo suppression means (13).

20. A device (1) as claimed in claim 2, in which the voice input means (10) comprise voice control command recognition means (14) which are designed to recognize at least one voice control command in the received acoustic signal (EA) and which, if at least one voice control command is recognizable in the received acoustic signal (EA), are designed to generate and output voice control command data (VCD) corresponding to the recognized voice control command, characterized in that the test means (15) are designed to test the functioning of the voice control command recognition means (14).

21. A device (1) as claimed in claims 18 and 19, characterized in that the test means (15) are designed for combined testing of the functioning of the acoustic receiving means (12) together with the functioning of the echo suppression means (13).

22. A device (1) as claimed in claims 19 and 20, characterized in that the test means (15) are designed for combined testing of the functioning of the echo suppression means (13) together with the functioning of the voice control command recognition means (14).

23. A device (1) as claimed in claim 6, characterized in that the test means (15) comprise test memory means (19) which are designed to store test information, and
in that the test means (15) comprise test signal generating means (17), which are designed to generate the test signal (TAS1, TD1, TD2, TD3, EA) with the aid of the stored test information.

24. A device (1) as claimed in claim 20, in which the voice control command recognition means (14) are designed to be trainable by a user of the device (1) with regard to a speech characteristic of the user and with regard to a number of voice control commands usable by the user, characterized in that the test means (15) are designed to test functioning of the trainable voice control command recognition means (14).

25. A device (1) as claimed in claim 24, characterized in that the test means (15) comprise training data memory means (25) which are designed to store training data (ED), wherein the training data (ED) may be generated during training of the voice control command recognition means (14) at least in part from the received acoustic signal (EA), and
in that the test means (15) are designed to test functioning of the trainable voice control command recognition means (14) with the aid of the training data (ED).

26. A device (1) as claimed in claim 24, characterized in that the test means (15) comprise reference data memory means (26) which are designed to store reference data (ND), wherein the reference data (ND) may be generated at least in part by means of original acoustic signals, which original acoustic signals comprise voice control commands which may be recognized by the voice control command recognition means (14) at the time of delivery of the device (1) to a user, and
in that the test means (15) are designed to test the functioning of the voice control command recognition means (14) with the aid of the reference data (ND).

27. A device (1) as claimed in claim 12, characterized in that the test means (15) comprise comparison means (18) which are designed to receive the result data (R1, R2, R3, R4) and to receive comparison information data (CID) and to compare the result data (R1, R2, R3, R4) with the comparison information data (CID), and
in that the comparison means (18) are designed to generate test result information representing a result of the comparison.

28. A device (1) as claimed in claim 27, characterized in that the device (1) comprises comparison information memory means (21) which are designed to store comparison information, and
in that the test means (15) are designed to access the comparison information memory means (21) and to output the comparison information data (CID) representing the comparison information to the comparison means (18).

29. A device (1) as claimed in claims 7 and 27, characterized in that the test means (15) are designed to receive comparison information data (CID) from the at least one device part (3, 4).

30. A method of controlling at least one controllable device part (2, 3, 4, 5) of a device (1), which method exhibits the following steps, namely
voice-actuated control of the at least one device part (2, 3, 4, 5) by voice control means (9), which voice control means (9) are designed to control the at least one device part (2, 3, 4, 5) by means of a receivable acoustic signal (EA), characterized in that functioning of the voice control means (9) is tested by test means (15).

31. A method as claimed in claim 30, characterized in that, during testing of the functioning of the voice control means (9) by means of the test means (15), a test signal (TAS1, TD1, TD2, TD3, EA) is fed to the voice control means (9).

32. A method as claimed in claim 31, characterized in that, during testing of the functioning of the voice control means (9) by means of the test means (15), the output acoustic signal (SA) is fed to the voice control means (9) as the test signal (EA).
